(19) United States
(12) Patent Application Publication
(10) Pub. No.: US 2011/0193017 A1
(43) Pub. Date: Aug. 11, 2011

(54) AUTOCLAVE REACTOR HEATING ASSEMBLY AND METHODS

(75) Inventors: Ricky Eugene Snelling, Tulsa, OK (US); Neil Allison Tillett, Bartlesville, OK (US); Donald Ray Engelbert, Copan, OK (US)

(73) Assignee: ConocoPhillips Company, Houston, TX (US)

(21) Appl. No.: 13/013,539

(22) Filed: Jan. 25, 2011

Related U.S. Application Data
(60) Provisional application No. 61/302,862, filed on Feb. 9, 2010.

(51) Int. Cl. B01J 19/00; C09K 3/00

(52) U.S. Cl. 252/182.11; 422/198

(57) ABSTRACT

Methods and systems relate to temperature control of autoclave reactor based reactions. The systems include an autoclave reactor vessel and a heater disposed external to the vessel with the heater and the vessel movable relative to one another using an actuator device. Operating the actuator device displaces the heater further from the vessel when desired to cool the reactor vessel, such as when quenching the reactions.

### CROSS-REFERENCE TO RELATED APPLICATIONS

This application is a non-provisional application which claims the benefit of and priority to U.S. Provisional Application Ser. No. 61/302,862 filed Feb. 9, 2010, entitled “Autoclave Reactor Heating Assembly and Methods,” which is hereby incorporated by reference in its entirety.

### STATEMENT REGARDING FEDERALLY SPONSORED RESEARCH OR DEVELOPMENT

None

### FIELD OF THE INVENTION

Embodiments of the invention relate to methods and systems for heating an autoclave reactor.

### BACKGROUND OF THE INVENTION

Many laboratory experiments run under controlled temperature and pressure conditions utilizing autoclave reactors. Electric heaters often heat the autoclave reactors used in labs to conduct the experiments. However, such heaters having resistive elements with accompanying insulation operate to retain heat preventing quenching of reactions in the autoclave reactors at desired reaction end times.

Controlling amount of time the reactions spend at temperature factors into calculations such as reaction rate measurements including corrosion rate determinations. Prolonged and variable cooling down of the autoclave reactor therefore introduces inaccuracy in final results or the calculations. For example, the cooling of the autoclave reactor can depend on how recently the heater cycled off before end of a particular run.

Commercial reactors may include internal passages or coils for flowing a heated fluid such as steam to heat the reactors and a cooling fluid such as water to later quench the reactions. However, limits on size and complexity make designs with the internal passages for cooling impractical for lab applications. The heater integral with the autoclave reactor or affixed to the autoclave reactor without operator disassembly thereby inhibits ability to control the temperature and conduct unattended experiments in the lab.

Therefore, a need exists for improved methods and systems for controlling the heat exposure time of an autoclave reactor.

### SUMMARY OF THE INVENTION

In one embodiment, a system includes an autoclave reactor vessel and a heater disposed external to the vessel. The heater and the vessel are movable relative to one another. The system further includes an actuator device operable to move the heater and the vessel relative to one another between a first position thermal coupling the heater with the vessel and a second position with the heater spaced from the vessel further relative to the first position.

According to one embodiment, a method includes reacting compositions in an autoclave reactor vessel. In addition, the method includes heating the reaction vessel with a heater disposed external to the vessel. Operating an actuator device separates the heater from an outer surface of the vessel upon an end of run for quenching the reacting of the compositions.

For one embodiment, a system includes an autoclave reaction vessel and a heating assembly that includes a split ring heating device clamped around a sleeve. The sleeve has an inner diameter sized to enable the sleeve to slide over the vessel receivable into the sleeve for heat transfer from the heating assembly to the vessel. Further, the system includes an actuator device operable to move the heating assembly and the vessel relative to one another thereby changing status of the vessel between being located inside of the sleeve and being located outside of the sleeve.

### BRIEF DESCRIPTION OF THE DRAWINGS

The invention, together with further advantages thereof, may best be understood by reference to the following description taken in conjunction with the accompanying drawings.

FIG. 1 is a view of a system with a heating assembly shown separated from an autoclave reactor vessel after a heated run cycle, according to one embodiment of the invention.

FIG. 2 is a view of the system with the heating assembly shown disposed around the autoclave reactor vessel during the heated run cycle, according to one embodiment of the invention.

FIG. 3 is a cross-section view of the system taken along line 3-3 of FIG. 2, according to one embodiment of the invention.

FIG. 4 is a graph illustrating influence from separation of the heating assembly and the autoclave reactor vessel on temperature cooling profiles at end of the heated run cycle, according to one embodiment of the invention.

### DETAILED DESCRIPTION OF THE INVENTION

Embodiments of the invention relate to methods and systems for temperature control of autoclave reactor based reactions. The systems include an autoclave reactor vessel and a heater disposed external to the vessel with the heater and the vessel movable relative to one another using an actuator device. Operating the actuator device displaces the heater further from the vessel when desired to cool the reactor vessel, such as when quenching the reactions.

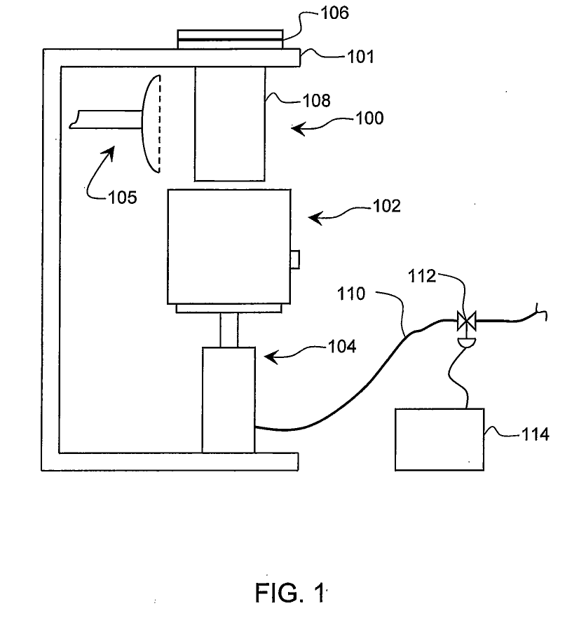

FIG. 1 illustrates an autoclave reactor vessel 100 mounted on a rack 101, an electric resistive heating assembly or heater 102 and an actuator device 104 coupled to provide relative movement between the reactor vessel 100 and the heater 102. During use, reactions take place within an internal sealed volume of the reactor vessel 100 that may be cylindrical in shape and hollow with closed or lidded ends to provide the sealed volume, which may be in fluid communication with ports into the sealed volume for introduction of reactants. Examples of pressurized (e.g., between about 2750 kilopascal (kPa) to about 3500 kPa) reactions within the reactor vessel include corrosion experiments for reaction rate measurements, such as corrosion rate determinations.

In a cooling or inactive position shown in FIG. 1, separation of the heater 102 from around the reactor vessel 100 enables heat to dissipate from the reactor vessel 100. The heat transfers from the reactor vessel 100 to surrounding atmosphere (e.g., at room temperature or about 20° C. to about 25° C.) without being inhibited by the heater 102. Residual heat due to thermal capacitance of the heater 102 does not continue to influence cooling of the reactor vessel 100 in the inactive position due to the separation. In some embodiments, an auxiliary external cooling source 105 shown only in FIG. 1 facilitates the cooling of the reactor vessel 100 and may include a fan and/or a compressed and/or chilled air or gas stream directed at the reactor vessel 100 while in the inactive position.

The rack 101 couples with a top portion 106 of the reactor vessel 100 leaving a bottom portion 108 of the reactor vessel 100 suspended extending beyond the rack 101. For example, the top portion 106 of the reactor vessel 100 may define an outward facing flange that rests on the rack 101. The heater 102 may define a donut or cup shape having an open interior area dimensioned to provide sliding clearance between the heater 102 and an outside surface of the reactor vessel 100 along the bottom portion 108 of the reactor vessel 100.

For some embodiments, the actuator device 104 supports the heater 102 and operates to move the heater 100 relative to the reactor vessel 100 held in a fixed location by the rack 101. The actuator device 104 in some embodiments provides the relative movement by imparting motion to the reactor vessel 100 or both the reactor vessel 100 and the heater 102. For example, the actuator device 104 may extend or retract the rack 101 or location of the reactor vessel 100 on the rack 101 or may support and link both the reactor vessel 100 and the heater 102.

Exemplary types of actuator devices 104 include motor driven geared or threaded mechanical arrangements or piston and cylinder assemblies such as illustrated. A conduit 110 couples to the actuator device 104 and includes a valve 112 for regulating pneumatic or hydraulic fluid supply to and from the actuator device 104. A controller 114 automates functioning of the actuator device 104 and may send signals to operate the valve 112 at programmed times, such as at an end of run. The controller 114 may also regulate other variables, such as flow rate through the reactor vessel 100, temperature of the heater 102 and pressure in the reactor vessel 100. When operated, the actuator device 104 switches status between the inactive position and an active position.

The piston and cylinder assembly shown represents only one exemplary configuration suitable to impart relative movement between the reactor vessel 100 and the heater 102. For example, other ways to provide the relative movement include lever devices (i.e., a see-saw action) or translating rotational movement of a threaded member into linear movement of the vessel 100 and/or the heater 102. For some embodiments, the heater 102 may fall under force of gravity away from the vessel 100 upon release, such as by actuation of an electromagnet that retains the heater 102 using magnetic attraction prior to the release.

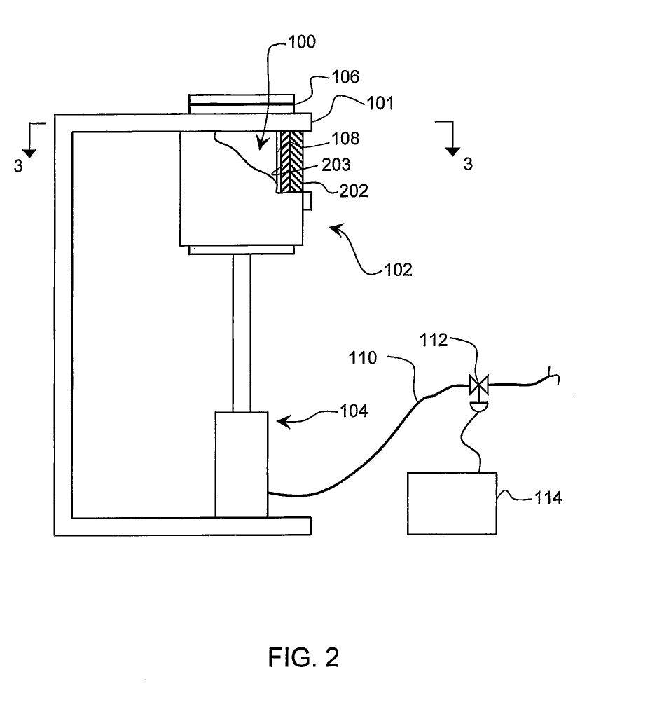

FIG. 2 shows the heater 102 and the autoclave reactor vessel 100 in the active position thermal coupling the heater 102 with the reactor vessel 100. The heater 102 surrounds the bottom portion 108 of the reactor vessel 100. Extension of the actuator device 104 moves the heater 102 in a linear direction along an axis of the reactor vessel 100 in common with that of the heater 102 aligned concentric with the reactor vessel 100. The heater 102 in the inactive position with the actuator device 104 retracted thus may space the heater 102 from the reactor vessel 100 along the axis making all of the reactor vessel 100 be outside of the heater 102. Throughout the run or duration of the experiment while the reactor vessel 100 is kept at reaction temperatures the actuator device 104 maintains the heater 102 and the reactor vessel 100 in the active position. Change from the active position to the inactive position may occur at the end of the run.

Sizing of an annular air gap between an outside of the reactor vessel 100 and an interior of the heater 102 limits insulating influence of the air gap to ensure heat transfer from the heater 102 to the reactor vessel 100. This clearance however permits sliding movement between the heater 102 and the reactor vessel 100 without requiring any mechanical decoupling to remove the heater 102 from being disposed around the reactor vessel 100. In some embodiments, the clearance is less than about 3 millimeters (mm), less than about 1.5 mm or between about 0.5 mm and about 3.0 mm.

In some embodiments, the heater 102 includes an outer heating device 202 and an inner sleeve 203. The heating device 202 may clamp to the inner sleeve 203 for physical engagement with the inner sleeve 203 and may be a commercially available design intended for clamping to the outside of the reactor vessel 100. Thermal conductivity provided by material of the sleeve 203 transfers heat generated by the heating device 202.

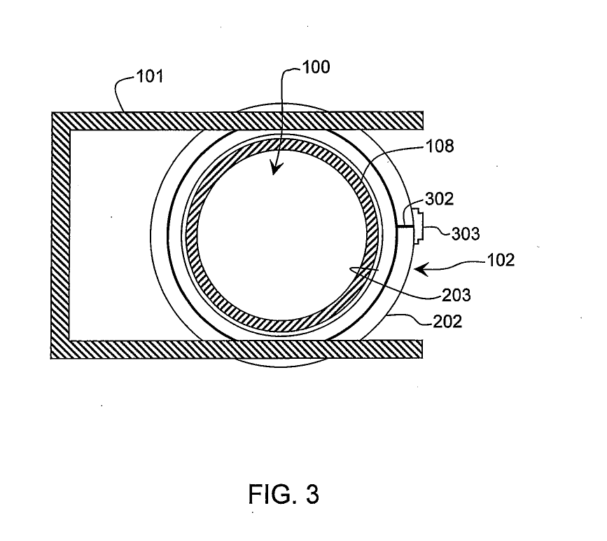

FIG. 3 illustrates a cross-section view taken along line 3-3 of FIG. 2. The sleeve 203 of the heater 102 having a continuous circumference provides support for clamping forces of the heating device 202. The heating device 202 opens and closes circumferentially along a longitudinal break 302 of the heating device 202. Once the sleeve 203 is positioned inside of the heating device 202, a latch 303 secures the longitudinal break 302 closed to affix the heating device 202 on the sleeve 203.

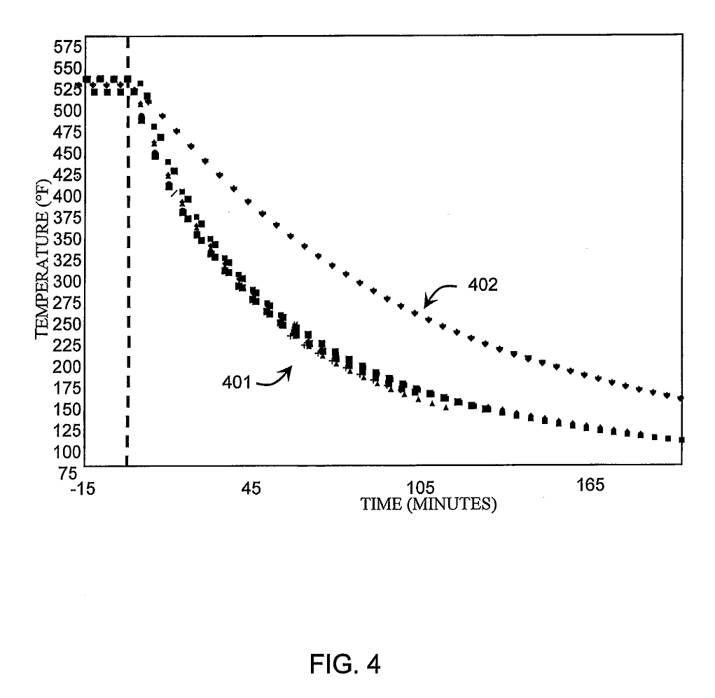

FIG. 4 shows a graph illustrating influence from separation of the heater 102 and the reactor vessel 100 on temperature cooling profiles upon termination of several heated run cycles. Dashed vertical line corresponds to when the heater 102 was turned off after maintaining the reactor vessel at 247° C. (575° F.) during the runs. Data points forming upper curve 402 were obtained when the heater 102 and the reactor vessel 100 were not separated. By contrast, data points forming lower curve 401 were obtained when the heater 102 was separated from the reactor vessel 100 at the end of the runs. As shown, multiple runs providing input for the lower curve 401 indicated reproducibility of results. Further, reaction fluid in the reactor vessel 100 stayed above 205° C. (400° F.) an additional 25 minutes when the reactor vessel 100 and the heater 102 were kept in the active position as opposed being switched to the inactive position at the end of the runs. When reactions being measured take place between 205° C. and 350° C., such additional time above 205° C. inhibits ability to quench reactions when desired. Stopping the reactions sooner when no longer maintaining the reaction temperature and in a consistent approach limits unwanted variations caused by experimental setup.

The preferred embodiment of the present invention has been disclosed and illustrated. However, the invention is intended to be as broad as defined in the claims below. Those skilled in the art may be able to study the preferred embodiments and identify other ways to practice the invention that are not exactly as described herein. It is the intent of the inventors that variations and equivalents of the invention are within the scope of the claims below and the description, abstract and drawings are not to be used to limit the scope of the invention.

1. A system comprising:
an autoclave reactor vessel;
a heater disposed external to the vessel, wherein the heater and the vessel are movable relative to one another; and
an actuator device operable to move the heater and the vessel relative to one another between a first position thermal coupling the heater with the vessel and a second position with the heater spaced from the vessel further relative to the first position.

2. The system according to claim 1, wherein the heater has an open interior area dimensioned to provide sliding clearance between the heater and an outside surface of the vessel.

3. The system according to claim 1, wherein the heater includes a sleeve around which a split ring heating device is clamped and into which the vessel is receivable.

4. The system according to claim 1, wherein the actuator device includes a piston and cylinder assembly that drives movement between the first and second positions.

5. The system according to claim 1, further comprising a controller programmable to automate operation of the actuator device.

6. The system according to claim 1, wherein in the first position the heater surrounds the vessel along a length of the vessel extending from where the vessel is supported.

7. The system according to claim 1, wherein the vessel is suspended at a first end thereof such that a second end of the vessel in the first position is inserted into a cavity of the heater and in the second position is disposed outside of the cavity of the heater.

8. The system according to claim 1, wherein the actuator device is coupled to move the heater relative to a fixed position of the vessel.

9. A method comprising:
reacting compositions in an autoclave reactor vessel;
heating the reactor vessel with a heater disposed external to the vessel; and
operating an actuator device to separate the heater from an outer surface of the vessel upon an end of run for the reacting of the compositions.

10. The method according to claim 9, wherein the reacting of the compositions includes conducting a corrosion experiment.

11. The method according to claim 9, further comprising calculating a corrosion rate based on the reacting of the compositions.

12. The method according to claim 9, wherein the operating of the actuator device is automated to occur at the end of the run.

13. The method according to claim 9, wherein the operating of the actuator device changes the vessel from being located inside the heater to being located outside the heater.

14. The method according to claim 9, further comprising clamping a split ring heating device around a sleeve to provide the heater.

15. The method according to claim 9, wherein the operating of the actuator device includes supplying fluid to a piston and cylinder assembly that drives separation of the heater from the vessel.

16. The method according to claim 9, wherein the operating of the actuator device includes moving the heater by supplying fluid to a piston and cylinder assembly upon which the heater is mounted.

17. The method according to claim 9, wherein the operating of the actuator device slides the vessel out of an open interior area of the heater dimensioned to provide sliding clearance between the heater and the outer surface of vessel.

18. A system comprising:
an autoclave reactor vessel;
a heating assembly that includes a split ring heating device clamped around a sleeve, wherein the sleeve has an inner diameter sized to enable the sleeve to slide over the vessel receivable into the sleeve for heat transfer from the heating assembly to the vessel; and
an actuator device operable to move the heating assembly and the vessel relative to one another thereby changing status of the vessel between being located inside of the sleeve and being located outside of the sleeve.

19. The system according to claim 18, wherein an annulus between the sleeve and the vessel is less than 1.6 millimeters.

20. The system according to claim 18, wherein the sleeve is a thermal conductor.
